(19) United States
(12) Patent Application Publication
(10) Pub. No.: US 2010/0321855 A1
(43) Pub. Date: Dec. 23, 2010

(54) Handheld stun device

(76) Inventor: Jules R. Shecter, Boca Raton, FL (US)

Correspondence Address: ROBERT M. DOWNEY, P.A., 6751 N. FEDERAL HWY., SUITE 300, BOCA RATON, FL, 33487, US

(21) Appl. No.: 12/803,137

(22) Filed: Jun. 18, 2010

Related U.S. Application Data
(60) Provisional application No. 61/269,049, filed on Jun. 18, 2009.

(51) Int. Cl. H01T 23/00

(52) U.S. Cl. 361/232

(57) ABSTRACT

A handheld electric stunning device has a main body defining housing for containing an internal battery source. A pair of spaced electrical probes on a front end of the main body are electrically connected to the battery source. A safety switch is operable to active and deactivate the device and is normally concealed by a cover that moves to reveal the safety switch. A power switch energizes the device and a trigger switch is operable to release a charge of electric current from the battery source to the electrical probes. A hand securing strap formed of an elastomeric material extends along a top side of the main body and is structured and disposed for receiving a user's hand between the strap and the housing with the strap stretched and pulled tight across the back of the user's hand, thereby firmly securing the device to the user's hand.

### BACKGROUND OF THE INVENTION

This non-provisional patent application is based on provisional patent application Ser. No. 61/269,049 filed on Jun. 18, 2009.

### FIELD OF THE INVENTION

The present invention relates to electrical devices which incapacitate a target through the means of a non-lethal electric shock and, more specifically, to a handheld device with a securing strap for use by one person as a means of self defense against an assault from another number of persons.

### DISCUSSION OF THE RELATED ART

Assaults by one person or a group of persons against a weaker and/or unsuspecting person are common and potentially result in injury of the victim, loss of victim's valuables, sexual assault of the victim, and in the worse scenarios, death of the victim. In scenarios where a weapon is not present for either party, the element of surprise is usually enough for an attacker to ensure that the victim will not be able to fight back or escape.

The most effective method for neutralizing an attacker in these situations is the delivery of a non-lethal electric shock for the purpose of disabling the attacker's movement capabilities temporarily, allowing for the victim to escape or call law enforcement. Many examples of prior art specifically directed to personal “stun guns” exist, and display a number of weaknesses which cannot be allowed for in situations of self defense.

Examples of prior art do not exhibit a shape of stun gun which is easily handheld or which allows for easy application to an attacker. At the same time, most examples of prior art demonstrate a shape which is easily recognizable by an attacker as an electrical stunning device, allowing the attacker to take steps to avoid being contacted by the device. Most importantly, examples of prior art do not provide a device which is difficult to remove from a user's hands. Prior devices can simply be knocked out of a user's hands by an attacker, rendering the device completely useless.

In view of the shortcomings associated with the design of personal electric stunning devices, there remains a need for a small handheld electrical stunning apparatus with a means of securing the apparatus to the hand of the user to prevent an attacker from knocking the apparatus out of the hand of the user.

### OBJECTS AND ADVANTAGES OF THE INVENTION

Considering the foregoing, it is a primary object of the present invention to provide a simple device that is held in the hand of the human for the purpose of delivering a non-lethal electric shock to a human.

It is a further object of the present invention to provide an electrical stunning device, as detailed above, which utilizes an expandable strap to secure the device to the hand of the user.

It is still a further object of the present invention to provide an electrical stunning device, as detailed above, which can deliver a significant electric current to render a target immobile after application of a shock.

These and other objects and advantages of the present invention are more readily adapted with reference to the detailed description and accompanying drawings.

### SUMMARY OF THE INVENTION

An electrical stunning device is generally compact in size and adapted to be held firmly in the grip on one hand. A power switch allows the user to alternate the device between being activated and deactivated, and a power button allows the user to deliver an electric current between electrodes or probes at a front end of the device. A securing strap extends from near a back end of the device to approximately halfway along the device or a length of at least 3 inches, allowing a user to secure his or her hand to the device. When the power button is pressed, and the power switch is set to “ON,” a powerful electric current is transmitted from one probe to the other probe. When the probes come into contact with a human, the electric current is rerouted through that human's body, interrupting the electrical signals sent by the central nervous system which control movement of the muscles. Additionally, this transmission of electric current causes the affected muscles to work rapidly and inefficiently, converting all available blood sugar into lactic acid, resulting in an energy loss which makes movement difficult. Simultaneously, the central nervous system's electrical signals for controlling body movement are interrupted and distorted, causing disorientation and loss of balance.

### BRIEF DESCRIPTION OF THE DRAWINGS

For a fuller understanding of the nature of the present invention, reference should be made to the following detailed description taken in conjunction with the accompanying drawings in which:

FIG. 1 is a side elevational view showing the electrical stunning device of the present invention;

FIG. 2 is a bottom perspective view showing the stunning device;

FIG. 3 is a bottom plan view showing the stunning device;

FIG. 4 is a front end elevational view of the stunning device showing the electrical probes;

FIG. 5 is a rear end elevational view of the stunning device showing a child safety switch with a slidable cover and a pair of lamp indicators for indicating both a deactivated status and an activated status of the stunning device; and

FIG. 6 is a perspective view showing the stunning device held firmly within the grasp of a user's hand with the securing strap extending over the back of the user's hand to effectively attach the stunning device to the user's hand.

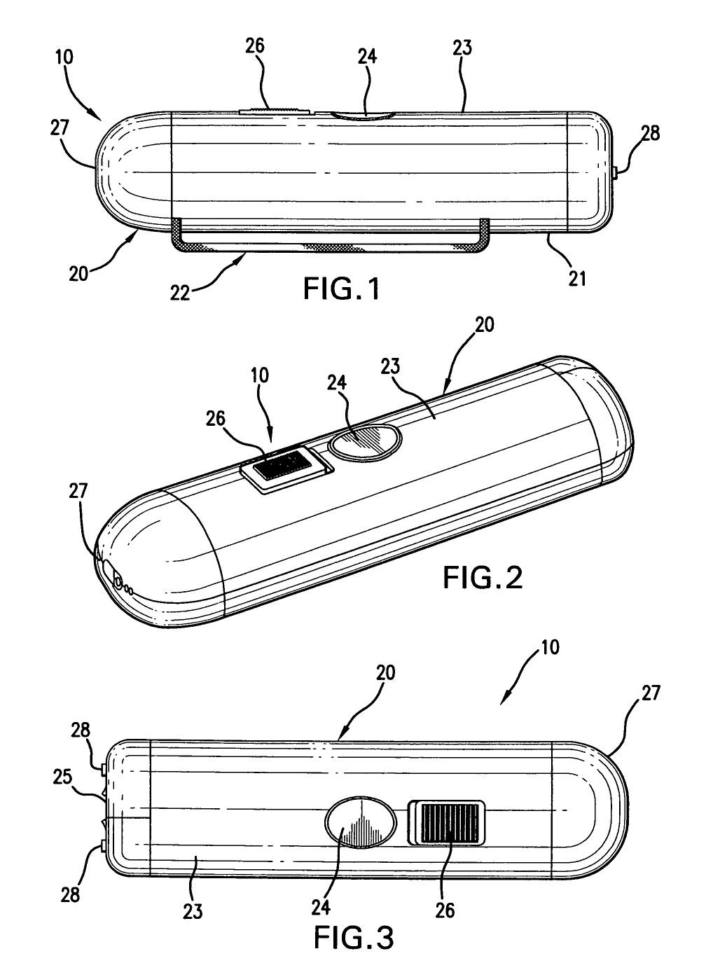

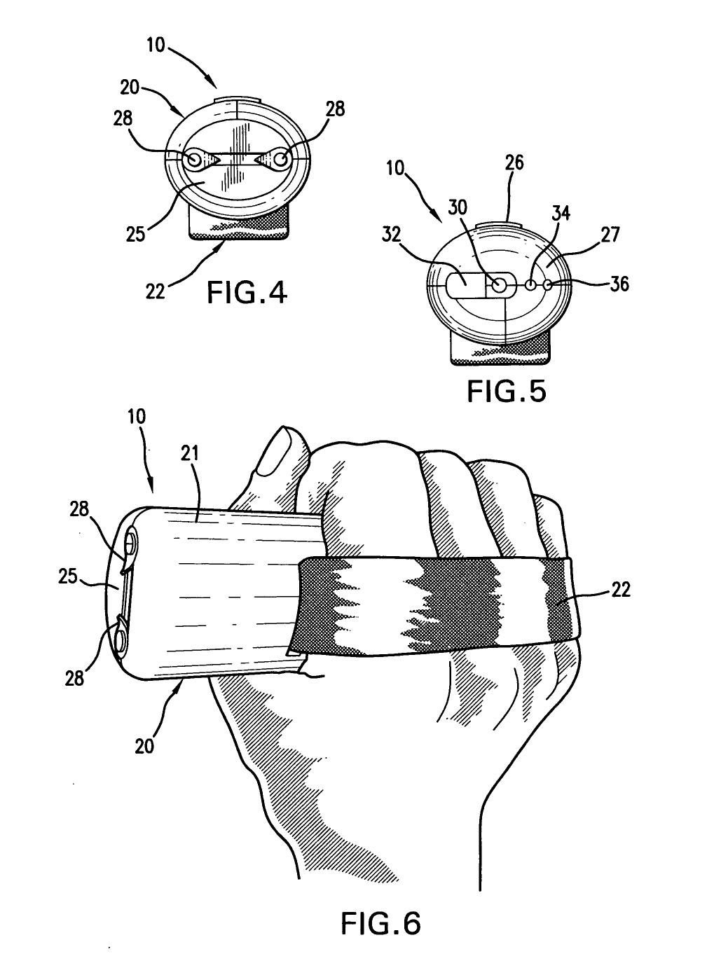

Like reference numerals refer to like parts throughout the several views of the drawings.

### DETAILED DESCRIPTION OF THE EMBODIMENTS

In the preferred embodiment, device 10 is comprised of a main body 20, hand securing strap 22, operation (trigger) button 24, power switch 26, and electrical probes 28. Hand securing strap 22 is held taut over the top side 21 of device 10. In a preferred embodiment, the strap 22 is made of an elastomeric material that stretches against an elastic memory force urging the strap 23 towards a normally relaxed state, wherein the strap 22 is flat and taut over the top side 21 of the device. The strap 22 is fixedly secured to the main body 20 at opposite ends and extends a length of at least three inches to allow passage of a user's hand under the strap 22. As shown in FIG. 6, the user places his/her hand under strap 22 and over the bottom side 21 which will secure the device 10 firmly within the user's grip and will effectively attach the device 10 to the user's hand so that the device 10 cannot be easily pulled out of the user's hand by an assailant.

Device 10 is electrically powered through an internal rechargeable battery. The charger port for plugging a electric cord into a wall outlet is located on a side of the main body 20. In order for the device 10 to be activated, a child safety switch 30 must be pressed by sliding a cover 32 to expose the safety switch 30. When activated, a lamp 34 on the rear end 27 of the device will illuminate. It is contemplated that this lamp 34 will have a green color for indicating the activated status. In order to deactivate the device, the safety switch 30 is again pressed which will illuminate a second lamp 36 for indicating the deactivated status. It is contemplated that the second lamp 36 will have a red color to indicate a deactivated status. When the device 10 is activated, the power switch 26 on bottom side 23 must first be switched to “ON.” After this, pressing of the trigger button 24 will cause a high voltage but low amperage electrical current to flow between electrical probes 28 on front end 25 of the device. When electrical probes 28 come into contact with a person, the electrical current disables the affected person's ability to move by interfering with electrical signals sent by the brain to the muscles and also by causing the muscles to rapidly and inefficiently produce sugar into lactic acid, resulting in a severe energy loss.

While the instant invention has been generally shown and described in accordance with a preferred and practical embodiment thereof, it is recognized that departures from the instant disclosure are contemplated within the spirit and scope of the present invention, which is not to be limited, except as defined in the following claims as interpreted under the Doctrine of Equivalents.

What is claimed is:

1. A handheld electric stunning device energized by an internal battery source, said device comprising:
a main body having a top side, a bottom side, a front end, and a rear end and adapted for encapsulating the internal battery source;
a safety switch operable for activating and deactivating the device;
a power switch operable to an “ON” position for energizing the device when activated and said power switch operable to an “OFF” position for de-energizing the device;
a cover moveable to a first position to reveal the safety switch and a second position to conceal the safety switch;
a plurality of spaced electrical probes on the first end of said main body for receiving a flow of electric energy from the battery source and between the spaced electrical probes;
a trigger switch for releasing the flow of electric energy from the battery source to the plurality of electrical probes upon operation thereof; and
a hand securing strap having opposite ends fixedly attached to said main body on the top side and extending at least three inches in length over said top side between the opposite ends, and said hand securing strap being structured and disposed for securing the device to a user's hand, and said hand securing strap being formed of an elastomeric material that is adapted to stretch against an elastic memory force urging said hand securing strap to a normally relaxed position wherein said hand securing strap is pulled taut and flat over the top side of said main body.

2. The device as recited in claim 1 wherein said hand securing strap is structured and disposed for receiving the user's hand between said hand securing strap and said main body with said hand securing strap stretched and held tight across the back of the user's hand.

3. The device as recited in claim 2 further comprising:
a first lamp structured and disposed to illuminate upon activation of the device.

4. The device as recited in claim 3 further comprising:
a second lamp structured and disposed to illuminate for indicating deactivation of the device.
